(19) United States
(12) Patent Application Publication
(10) Pub. No.: US 2025/0125541 A1
(43) Pub. Date: Apr. 17, 2025

(54) POWER LINE CLAMP

(71) Applicant: Hubbell Incorporated, Shelton, CT (US)

(72) Inventor: Pieter Jere Beckman, Manchester, NH (US)

(21) Appl. No.: 18/913,283

(22) Filed: Oct. 11, 2024

Related U.S. Application Data
(60) Provisional application No. 63/590,049, filed on Oct. 13, 2023.
(60) Provisional application No. 63/695,470, filed on Sep. 17, 2024.

(51) Int. Cl. H01R 4/36

(52) U.S. Cl. CPC H01R 4/366

(57) ABSTRACT

An electrical connector includes a clamp body having a base, a side portion, and an upper portion. The clamp body defines a cable groove having an arched configuration configured to receive a primary conductor and an aperture for receiving a secondary conductor. A primary fastener is movably connected to the clamp body. A keeper is connected to the clamp body and moveable with the primary fastener to secure the primary conductor in the cable groove. A secondary fastener is configured to receive the secondary conductor in the aperture.

### RELATED APPLICATION(S)

This application is based on U.S. Provisional Application No. 63/590,049, filed Oct. 13, 2023, and U.S. Provisional Application No. 63/695,470, filed Sep. 17, 2024, the disclosures of which are incorporated herein by reference in their entirety and to which priority is claimed.

### FIELD

Various exemplary embodiments relate to an electrical connector for a utility power line.

### BACKGROUND

A power line clamp connector is used to make a permanent or temporary connection to an overhead power distribution line. Some examples of power line clamp connectors include hotline clamps and piggyback clamps which are used to connect a tap line to a primary conductor. These types of clamps can be used to hold a tap line in position with a main conductor while a more permanent connection is made. Typically, these connectors are installed by a lineman using a hot stick.

### SUMMARY

In certain configurations, an electrical connector includes a clamp body having a primary cable connection and a secondary cable connection.

In certain configurations, an electrical connector includes a clamp body having a primary cable groove. The primary cable groove includes an arched configuration.

In certain configurations, an electrical connector includes a clamp body having a primary cable groove and a secondary cable groove. The primary cable groove and the secondary cable groove include an arched configuration.

In certain configurations, an electrical connector includes a clamp body having a primary cable groove. A plurality of teeth extend into the cable groove at a downward angle to engage a primary cable.

In certain configurations, an electrical connector includes a clamp body having a primary cable connection and a secondary cable connection. The secondary cable connection incudes a secondary fastener. The clamp body is configured to provide a spring force to a secondary conductor when engaged with the secondary fastener.

In certain configurations, an electrical connector includes a clamp body having a primary cable connection and a secondary cable connection. The secondary cable connection incudes a boss having a cantilever rear wall. An aperture extends through the rear wall to receive a secondary fastener.

In certain configurations, an electrical connector includes a clamp body defining a cable groove configured to receive a primary conductor. A primary fastener is movably connected to the clamp body. A keeper is connected to the clamp body and moveable with the primary fastener to secure the primary conductor in the cable groove. A retaining pin is received in the keeper to secure the keeper to the primary fastener.

In certain configurations, an electrical connector includes a clamp body having a base, a side portion, and an upper portion. The clamp body defines a cable groove having an arched configuration configured to receive a primary conductor and an aperture for receiving a secondary conductor. A primary fastener is movably connected to the clamp body. A keeper is connected to the clamp body and moveable with the primary fastener to secure the primary conductor in the cable groove. A secondary fastener is configured to receive the secondary conductor in the aperture.

In certain configurations, an electrical connector includes a clamp body having a base, a side portion, and an upper portion. The clamp body defines a first cable groove having an arched configuration configured to receive a primary conductor and a second cable groove having an arched configuration configured to receive a secondary conductor. A primary fastener is movably connected to the clamp body. A primary keeper is connected to the clamp body and moveable with the primary fastener to secure the primary conductor in the first cable groove. A secondary fastener is movably connected to the clamp body. The secondary keeper is connected to the clamp body and moveable with the secondary fastener to secure the secondary conductor in the second cable groove.

In certain configurations, an electrical connector includes a clamp body having a base, a side portion, and an upper portion. The clamp body defines a cable groove and having a plurality of teeth extending into the cable groove at a downward angle. A primary fastener is movably connected to the clamp body. A keeper is connected to the clamp body and moveable with the primary fastener to secure the primary conductor in the cable groove. A secondary fastener is configured to receive the secondary conductor in the aperture.

In certain configurations, an electrical connector includes a clamp body having a base, a side portion, and an upper portion. The clamp body defines a first cable groove and a second cable groove. A plurality of first teeth extend into the first cable groove at a downward angle. A plurality of second teeth extend into a second cable groove at a downward angle. A primary fastener is movably connected to the clamp body. A primary keeper is connected to the clamp body and moveable with the primary fastener to secure the primary conductor in the first cable groove. A secondary fastener is movably connected to the clamp body. A secondary keeper is connected to the clamp body and moveable with the secondary fastener to secure the secondary conductor in the second cable groove.

In certain configurations, an electrical connector includes a clamp body having a base, a side portion, an upper portion, and a boss. The clamp body defines a cable groove configured to receive a primary conductor and an aperture for receiving a secondary conductor. A primary fastener is movably connected to the clamp body. A keeper is connected to the clamp body and moveable with the primary fastener to secure the primary conductor in the cable groove. A secondary fastener is configured to secure the secondary conductor in the aperture. The clamp body is configured to provide a spring force to the secondary conductor when engaged with the secondary fastener.

In certain configurations, an electrical connector includes a clamp body having a base, a side portion, an upper portion, and a boss. The clamp body defines a cable groove configured to receive a primary conductor and an aperture for receiving a secondary conductor. A primary fastener is movably connected to the clamp body. A keeper is connected to the clamp body and moveable with the primary fastener to secure the primary conductor in the cable groove. A secondary fastener is configured to secure the secondary conductor in the aperture. The boss includes a cantilevered rear wall receiving the secondary fastener.

In certain configurations, an electrical connector includes a clamp body having a base, a side portion, an upper portion, and a boss. The clamp body defines a cable groove configured to receive a primary conductor. The boss includes a lower wall extending from the side portion, a rear wall extending from the lower wall, and an aperture in the rear wall for receiving a secondary conductor. A primary fastener is movably connected to the clamp body. A keeper is connected to the clamp body and moveable with the primary fastener to secure the primary conductor in the cable groove. A secondary fastener is configured to secure the secondary conductor in the aperture. The rear wall is configured to provide a spring force to the secondary conductor when engaged with the secondary fastener.

In certain configurations, an electrical connector includes a clamp body having a base, a side portion, an upper portion. The clamp body defining a cable groove configured to receive a primary conductor and an aperture for receiving a secondary conductor. A primary fastener is movably connected to the clamp body. A keeper is connected to the clamp body and moveable with the primary fastener to secure the primary conductor in the cable groove. A retaining pin is received in the keeper to secure the keeper to the primary fastener. A secondary fastener is configured to receive the secondary conductor in the aperture.

### BRIEF DESCRIPTION OF THE DRAWINGS

The following drawings present non-liming, exemplary configurations and implementations of various aspects of the invention.

FIG. 1 is a perspective view of an exemplary configuration of a utility line electrical connector.

FIG. 2 is a side view of FIG. 1.

FIG. 3 is a side, magnified view of the cable groove of the connector.

FIG. 4 is a perspective, magnified view of the cable groove of FIG. 3.

FIG. 5 is a perspective view of another configuration of a utility line electrical connector.

FIG. 6 is a perspective view of another configuration of a utility line electrical connector.

FIG. 7 is a side view of FIG. 6.

FIG. 8 is a perspective view of another configuration of a utility line electrical connector.

FIG. 9 is a side view of another utility line electrical connector.

FIG. 10 is a top perspective view of the clamp of FIG. 9.

FIG. 11 is a bottom perspective view of the clamp of FIG. 9.

FIG. 12 is a partial side view of the clamp of FIG. 9.

FIG. 13 is a partial top view of the clamp of FIG. 9.

FIG. 14 is a perspective view of another configuration of a utility line electrical connector.

FIG. 15 is a perspective view of the primary fastener and keeper of the connector of FIG. 14.

FIG. 16 is a side, partial view of the primary fastener and keeper of FIG. 15, with the keeper in wireframe to show the internal structure.

FIG. 17 is a perspective view of another configuration of a utility line electrical connector.

### DETAILED DESCRIPTION

Various implementations are directed to an electrical connector configured to electrically connect a first electrical conductor to a second electrical conductor. In certain configurations the electrical conductors can be utility line power conductors. The first conductor can be a main conductor such as a run cable, or feeder cable, conductor for example. The second conductor can be a tap wire, or tap line, conductor for example. However, it should be understood that alternative embodiments may accommodate any combination of conductor types and/or sizes.

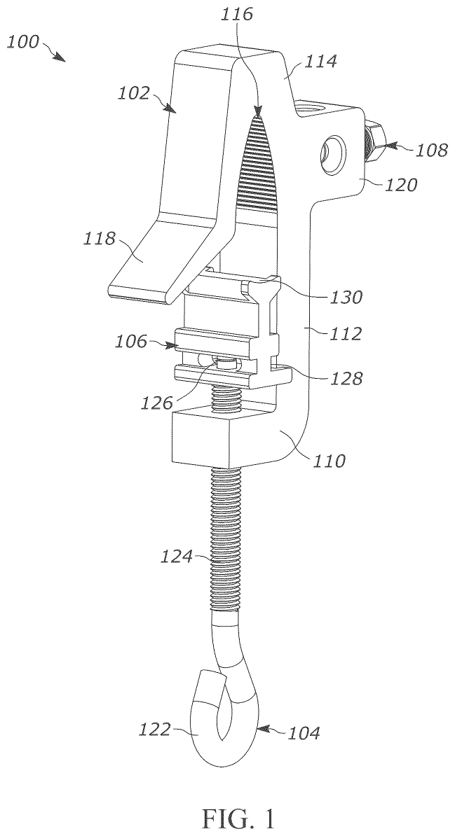

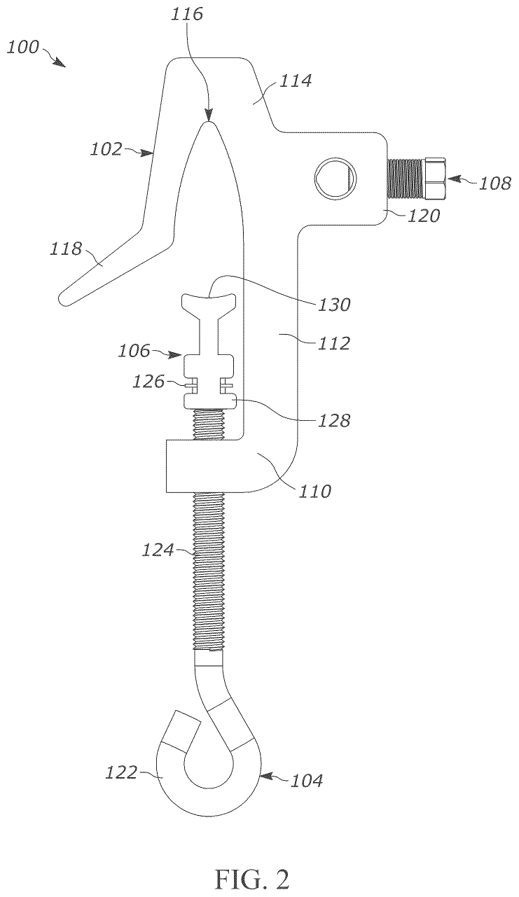

FIG. 1 shows an exemplary configuration of a connector 100 having a hot line clamp configuration. The connector 100 has a clamp body 102, a primary fastener 104, a keeper 106, and a secondary fastener 108. The hot line connector 100 is configured to receive a primary conductor and a secondary conductor in the clamp body 102 to make an electrical connection between the two conductors.

In various configurations, the clamp body includes a base 110 with an aperture for receiving the primary fastener 104. A side portion 112 extends upwardly from the base 110. An upper portion 114 extends outwardly from the side portion 112 and defines a cable groove 116. The upper portion 114 can include a forward extension 118 which extends outwardly from the cable groove 116. The forward extension 118 can extend at an oblique angle away from the cable groove 116 and down toward the base 110.

A boss 120 extends from the rear of the upper portion 114. The boss 120 includes an aperture for receiving the secondary fastener and one or more apertures from receiving a secondary conductor. The secondary or tap conductor can be inserted into one of the openings in the boss 120 and the secondary fastener 108 can be tightened to secure the secondary conductor.

In certain configurations the primary fastener 104 includes an eye 122 and a threaded portion 124. The keeper 106 is connected to the end of the primary fastener 104 by a retaining ring 126. In an exemplary operation, the eye 122 can be engaged by a hot stick and the primary fastener 104 rotated to move the keeper 106 relative to the cable groove 116 to retain a conductor. The keeper 106 can be rotatably connected to the primary fastener 104 so that rotational position of the keeper 106 remains relatively steady with respect to the primary fastener 104 during rotation. The keeper 106 can include a keeper body 128 having one or more projections. The upper projection can include a curved outer surface 130 for receiving a conductor.

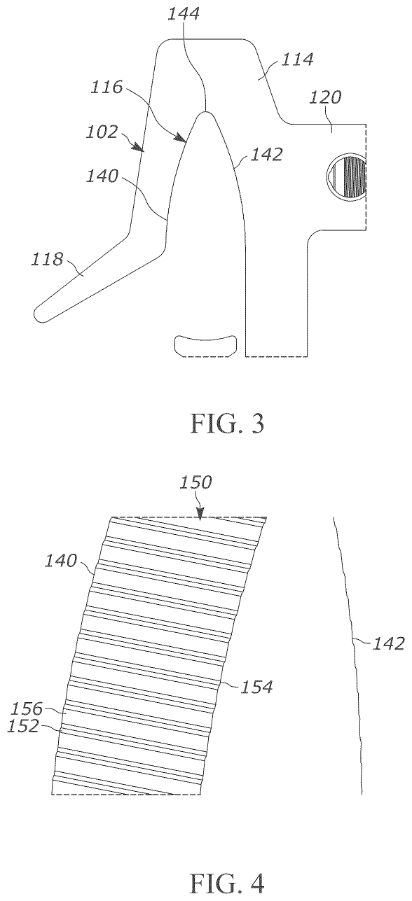

The cable groove 116 is configured to receive various sized primary conductors. As best shown in FIG. 3, the cable groove 116 can include an outer wall 140, an inner wall 142, and an upper wall 144. In certain configurations, the outer wall 140, inner wall 142, and upper wall 144 can have an arched configuration. In the illustrated embodiment the cable groove has a substantially ogival (aka gothic) arch configuration with a curving outer wall, inner wall 142, and a pointed upper wall 144. Although an ogival arch is shown, various other arched configurations can be used with different curved sides and other crown or point configurations. For example, other embodiments can utilize a segmented, semicircular, trefoil, basket, parabolic, tudor, rampant, acute, or ogee arch configuration can be used.

Typical clamps utilize a V-shaped cable groove with substantially rectilinear sides meeting in a point. The arched configuration provides improvements of the V-shaped design in that the curvature of the arch can help form enhanced contact with the conductor when pressed into the cable groove 116. The arched configuration can also be easier to release the conductor, as a V-shaped groove can require more force to deform and seat the conductor during installation. The arched configuration can also allow for a greater range of conductors to be used. For example, various embodiments of hot line connectors can be configured to operate in a small range, with a main conductor range of #4 to 4/0 ACSR or a diameter of 0.232 to 0.563 inches and a tap conductor range of #8 to 2/0 AAC or a diameter of 0.128 to 0.414 inches, a medium range, with a main conductor range of 1/0 to 795 AAC or a diameter of 0.368 to 1.027 inches or a tap conductor range of #8 to 4/0 AAC or a diameter of 0.128 to 0.522 inches, and a large range, with a main conductor range of 636 to 1033.5 ACSR or a diameter of 0.918 to 1.245 inches and a tap conductor range of #8 to 4/0 AAC or a diameter of 0.128 to 0.522 inches.

In various exemplary configurations, the cable groove 116 can include a plurality of teeth 150 as best shown in FIG. 4. Each of the teeth 150 can have a first side 152, a peak 154, and a second side 156. The teeth can have an angled, stepped configuration so that the first side 152 is shorter than the second side 156 and the peak 154 is at a downward, oblique angle relative to the outer wall 140 and inner wall 142. This configuration can allow the teeth 150 to better grip the primary conductor and provide abrasion during insertion that facilitates a better connection, while also allowing for easier removal of the primary conductor if needed.

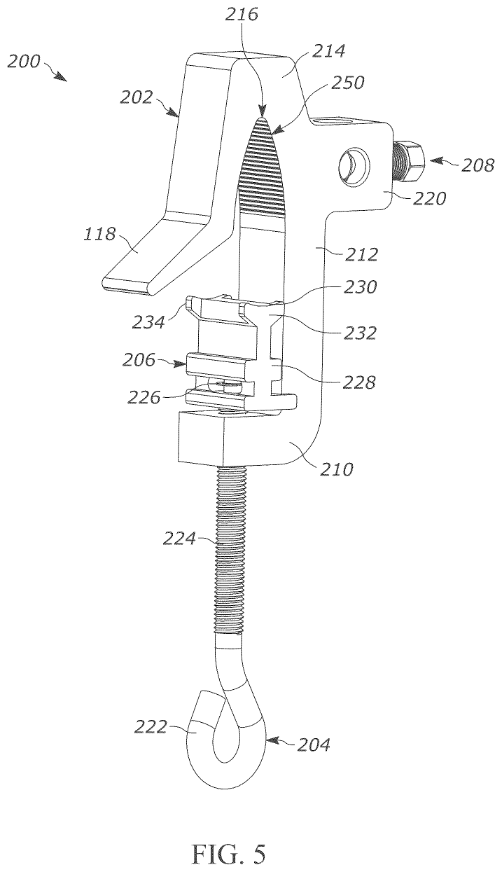

FIG. 5 shows another exemplary configuration of a connector 200 having a similar configuration as a hot line clamp with a clamp body 202, a primary fastener 204, a keeper 206, and a secondary fastener 208. The clamp body 202 includes a cable groove 216 with an arched configuration and angled teeth 250.

In various embodiments, the clamp body includes a base 210 with an aperture for receiving the primary fastener 204. A side portion 212 extends upwardly from the base 210. An upper portion 214 extends outwardly from the side portion 212 and defines a cable groove 216. The upper portion 214 can include a forward extension 218 which extends outwardly from the cable groove 216. The forward extension 218 can extend at an oblique angle away from the cable groove 216 and down toward the base 210.

A boss 220 extends from the rear of the upper portion 214. The boss 220 includes an aperture for receiving the secondary fastener 208 and one or more apertures from receiving a secondary conductor. The secondary or tap conductor can be inserted into one of the openings in the boss 220 and the secondary fastener 208 can be tightened to secure the secondary conductor.

In certain configurations the primary fastener 204 includes an eye 222 and a threaded portion 224. The keeper 206 is connected to the end of the primary fastener 204 by a retaining ring 226. In an exemplary operation, the eye 222 can be engaged by a hot stick and the primary fastener 204 rotated to move the keeper 206 relative to the cable groove 216 to retain a conductor. The keeper 206 can be rotatably connected to the primary fastener 204 so that rotational position of the keeper 206 remains relatively steady with respect to the primary fastener 204 during rotation. The keeper 206 can include a keeper body 228 having one or more projections. The upper projection can include a curved outer surface 230 for receiving a conductor. The upper projection can also include a first set of arms 232 and a second set of arms 234 that extend outwardly from the keeper 206 to form a larger seat for receiving the primary conductor. The arms 232, 234 can extend past the walls of the cable groove 216 when a conductor is seated in the cable groove 216 and the primary fastener is tightened to secure the conductor.

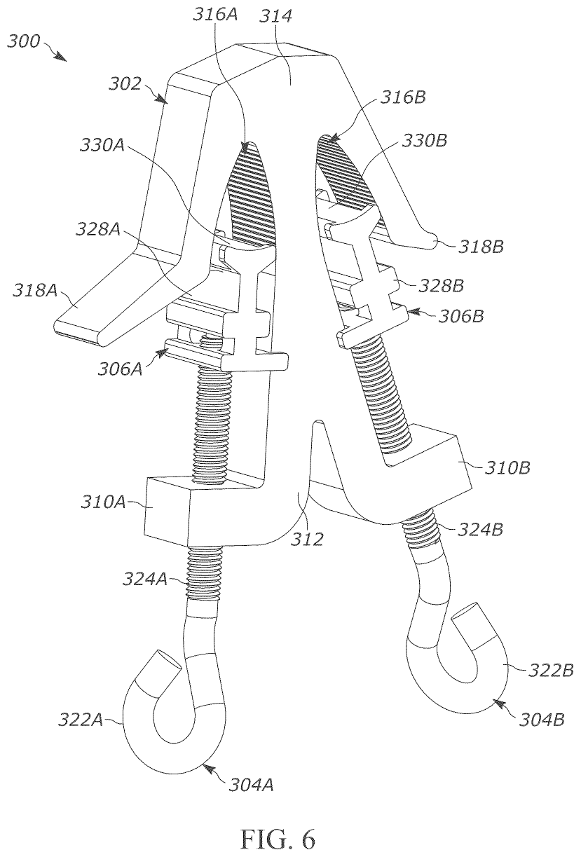

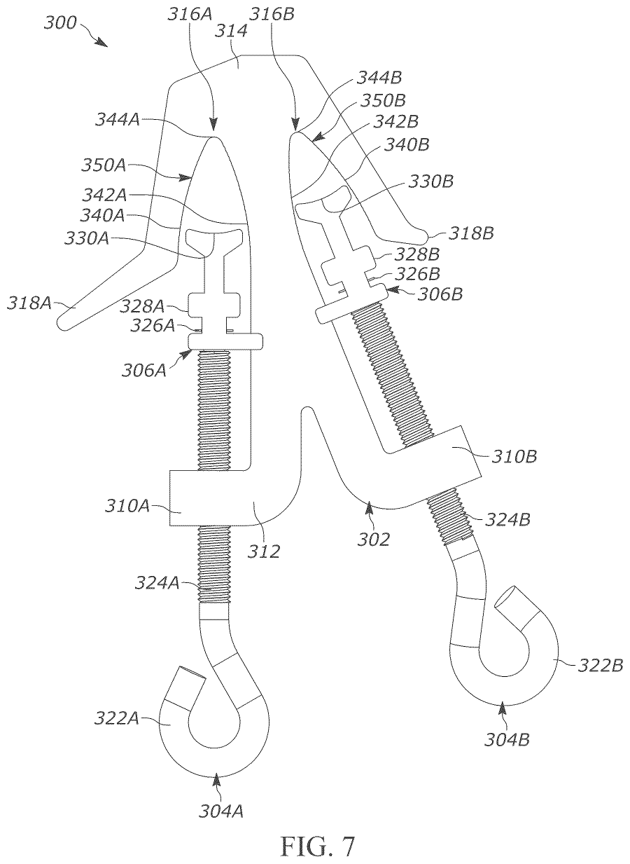

FIGS. 6 and 7 show an exemplary embodiment of a connector 300 having a piggyback clamp configuration. The connector 300 has a clamp body 302, a primary fastener 304A, a primary keeper 306A, a secondary fastener 304B, and a secondary keeper 306B. The hot line connector 300 is configured to receive a primary conductor and a secondary conductor in the clamp body 302 to make an electrical connection between the two conductors.

In various embodiments, the clamp body includes a primary base 310A with an aperture for receiving the primary fastener 304A and a secondary base 310B with an aperture for receiving the secondary fastener 304B. A side portion 312 extends upwardly from the primary base 310A and the secondary base 310B. An upper portion 314 extends outwardly from the side portion 312 and defines a primary cable groove 316A and a secondary cable groove 316B. The upper portion 314 can include a forward extension 318A which extends outwardly from the primary cable groove 316A and a rearward extension 318B which extends outwardly form the secondary cable groove 316B. The extensions 318A, 318B can extend at an oblique angle away from the respective cable groove 316A, 316B and down toward the respective base 310A, 310B. As best shown in FIG. 7, the secondary cable groove 316B and the secondary fastener 304B can be oriented at an oblique angle to the primary cable groove 316A and the primary fastener 304A.

In certain configurations the primary fastener 304A and the secondary fastener 304B each include an eye 322A, 322B and a threaded portion 324A, 324B. The keepers 306A, 306B are connected to the end of the fastener 304A, 304B by a retaining ring 326A, 326B. In an exemplary operation, the eyes 322A, 322B can be engaged by a hot stick and the fasteners 304A, 304B rotated to move the keepers 306A, 306B relative to the cable grooves 316A, 316B to retain a conductor. The keepers 306A, 306B can be rotatably connected to the fasteners 304A, 304B so that rotational position of the keepers 306A, 306B remains relatively steady with respect to the fastener 304A, 304B during rotation. The keepers 306A, 306B can include a keeper body 328A, 328B having one or more projections. The upper projections can include a curved outer surface 330A, 330B for receiving a conductor.

The cable grooves 316A, 316B are configured to receive various sized conductors. As best shown in FIG. 7, the cable grooves 316A, 316B can include an outer wall 340A, 340B, an inner wall 342A, 342B, and an upper wall 344A, 344B. In certain configurations, the outer wall 340A, 340B, inner wall 342A, 342B, and upper wall 344A, 344B can have an arched configuration with angled teeth 350A, 350B.

The arched configuration of the cable grooves 316A, 316B can allow for a larger range of conductors to be used with the connector 300. For example, various embodiments of piggyback connectors can be configured to operate in a small range, with a main conductor range and tap conductor range of 1/0 to 397.5 ACSR or a diameter of 0.368 to 0.806 inches, a medium range, with a main conductor range and tap conductor range of 336.4 to 795 AAC or a diameter of 0.665 to 1.027 inches, and a large range, with a main conductor range of 636 to 1033.5 ACSR or a diameter of 0.918 to 1.245 inches and a tap conductor range of 500Cu to 1033.5 ACSR or a diameter of 0.813 to 1.245 inches.

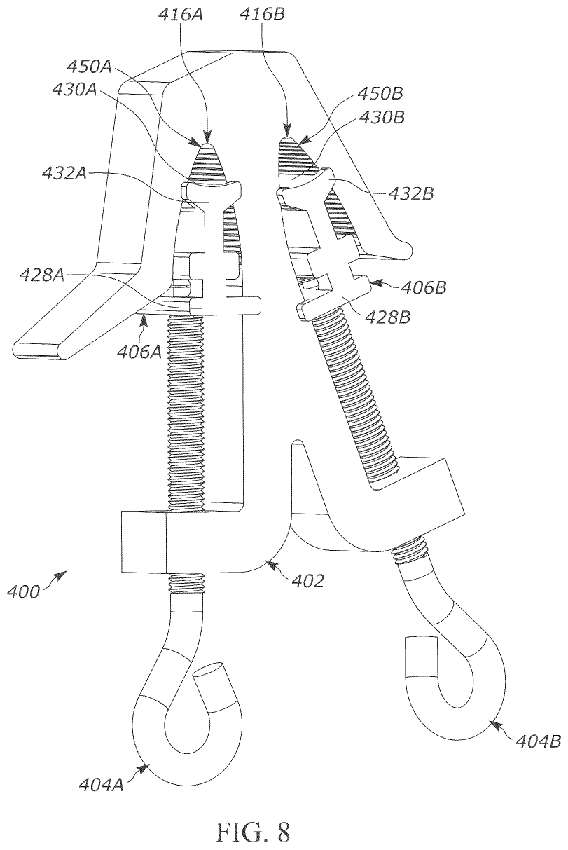

FIG. 8 shows another exemplary embodiment of a connector 400 having a similar configuration as a piggyback clamp. The connector 400 has a clamp body 402, a primary fastener 404A, a primary keeper 406A, a secondary fastener 404B, and a secondary keeper 406B. The connector 400 is configured to receive a primary conductor and a secondary conductor in the clamp body 402 to make an electrical connection between the two conductors. The clamp body 402 includes a primary cable groove 416A with an arched configuration and with angled teeth 450A and a secondary cable groove 416B with an arched configuration and angled teeth 450B. The primary keeper 406A and the secondary keeper 406B include a keeper body 428A, 428B having one or more projections. The upper projection can include a curved outer surface 430A, 430B for receiving a conductor. The upper projection can also include a first set of arms 432A, 432B and a second set of arms that extend outwardly from the keeper 406A, 406B to form a larger seat for receiving the conductors. The arms 432A, 432B, can extend past the walls of the cable groove 416A, 416B when a conductor is seated in the cable groove 416A, 416B and the fasteners 404A, 404B are tightened to secure the conductor.

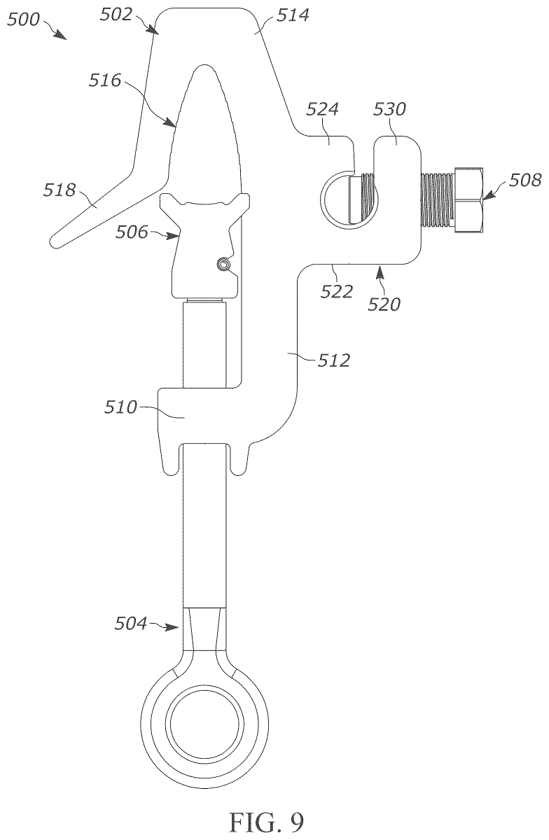

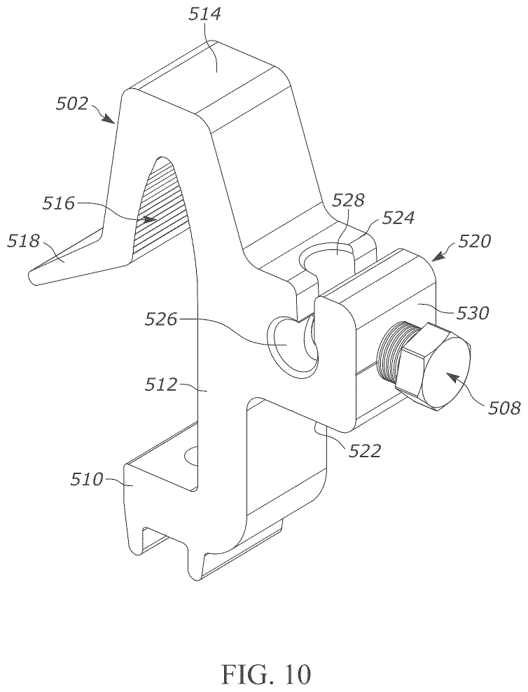

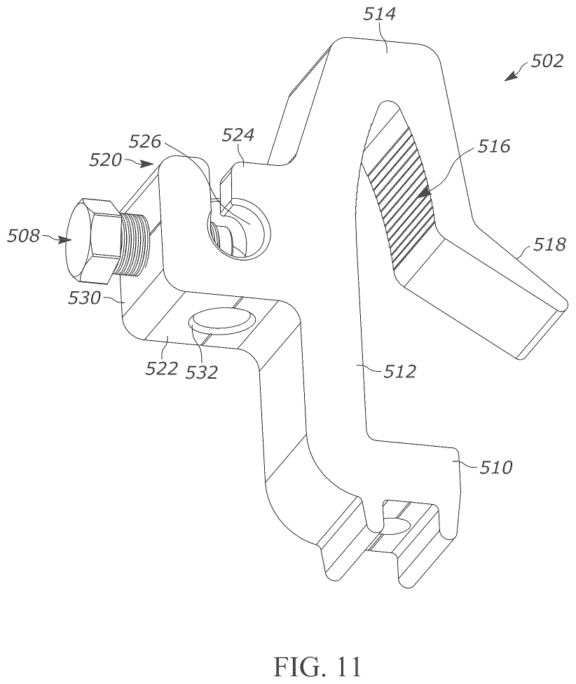

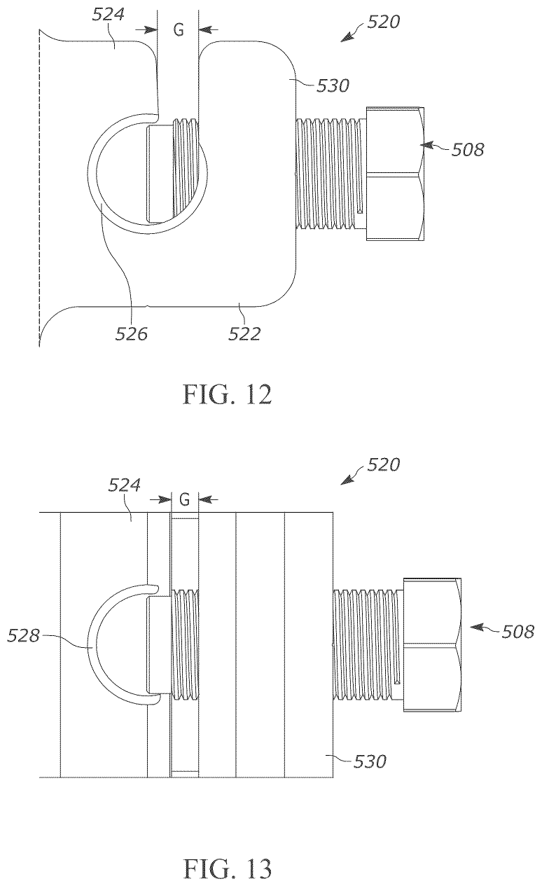

FIG. 9 shows another configuration of a connector 500 having a similar configuration as a hot line clamp with a clamp body 502, a primary fastener 504, a keeper 506, and a secondary fastener 508. The clamp body 502 includes a cable groove 516 with an arched configuration.

In various configurations, the clamp body 502 includes a base 510 with an aperture for receiving the primary fastener 504. The base 510 can include a set of protrusions extending below the aperture to act as an interface with a hot stick to prevent rotation of the clamp body 502 during installation. A side portion 512 extends upwardly from the base 510. An upper portion 514 extends outwardly from the side portion 512 and defines a cable groove 516. The upper portion 514 can include a forward extension 518 which extends outwardly from the cable groove 516. The forward extension 518 can extend at an oblique angle away from the cable groove 516 and down toward the base 510.

A boss 520 extends from the rear of the upper portion 514. The boss 520 includes an aperture for receiving the secondary fastener 508 and one or more apertures from receiving a secondary conductor. The secondary or tap conductor can be inserted into one of the openings in the boss 520 and the secondary fastener 208 can be tightened to secure the secondary conductor.

In certain configurations, the boss 520 includes a spring portion that is capable of providing a torque force to a clamped secondary conductor. For example, the boss 520 can be structured to provide a clamping force in addition to the secondary fastener 508 when a secondary conductor is installed. This clamping force can be from a cantilevered portion that creates a moment when the secondary fastener 508 is tightened that provides an additional spring force to the secondary fastener 508.

In the illustrated embodiment, the boss 520 includes a lower wall 522 extending from the side portion 512 of the clamp body 502. The lower wall 522 can extend along the width of the side portion 512 and extend outwardly from the clamp body 502. A lower opening 532 can be provided in the lower wall 522 for receiving the secondary conductor in a vertical orientation. The lower opening 532 can have a chamfered surface to provide easier insertion of the secondary conductor.

One or more upper arms 524 extend from the side portion 512 spaced from the lower wall 522. The upper arms 524 can include a curvilinear lower surface 526 that transitions to the lower wall 522, defining a curved opening in the side of the boss 520. The curved opening can have a chamfered leading edge. In the illustrated embodiment the curved opening is substantially circular, although other curved configurations can be used. The curved openings 526 can receive a secondary conductor in a horizontal orientation.

The upper arms 524 can also be connected by a curvilinear upper surface 528. In the illustrated embodiment the curved upper surface 528 is substantially circular, although other curved configurations can be used. The upper surface 528 can combine with the lower opening 532 to receive a secondary conductor in a vertical orientation. The upper surface 528 can have a chamfered leading edge. The upper arms 524 can be any other types of projections extending from the clamp body 502 and in certain configurations the no projections can be used.

A rear wall 530 extends upwardly from the lower wall 522 in a direction away from the base 510. The rear wall 530 can include the opening for receiving the secondary fastener 508. The upper edge of the rear wall 530 can be rounded to help prevent corona buildup and discharge.

The rear wall 530 is spaced from the upper arms 524 to form a spring gap G between the upper arms 524 and the rear wall 530. The rear wall 530 therefore extends from the lower wall 522 in cantilevered fashion. The spring gap G allows the rear wall 530 to deflect relative to the side portion 512 of the clamp body 502. In certain configurations the spring gap G can be defined between the rear wall 530 and the side portion 512.

Conventional style conductor tap clamps can result in the loosening of the tap conductor over time due to material creep deformation. Materials will undergo creep deformation from clamping pressure, and common conductor materials (i.e. aluminum, copper) and multi strand conductors are more susceptible to creep than hard and solid materials. Elevated temperatures increase the potential for creep, and current carrying conductors experience elevated temperatures during use. When a conventional “bolt-and-hole” clamp bolt is torqued onto a conductor during installation, the clamping force will relax as the conductor material creeps, this relaxation will continue over time and temperature.

The boss 520 can provide a spring force during installation of the tap conductor. Tightening the secondary fastener 208 can cause deflection of the rear wall 530, widening the spring gap G. In turn, the rear wall 530 will provide a resilient spring force which will act to push the secondary fastener 508 tighter against the secondary conductor. This provides superior clamping force on the conductor over temperature and time and mitigates the risk of creep induced connector to conductor contact failure.

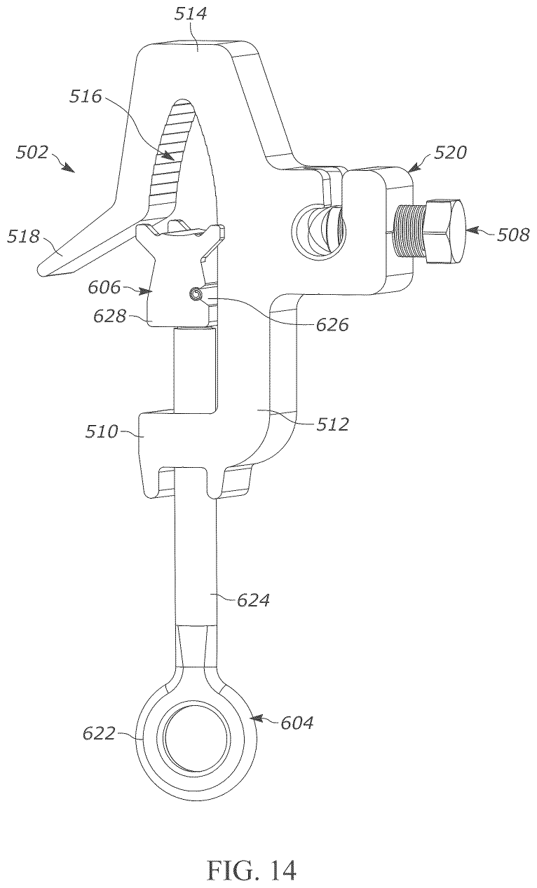

FIG. 14 shows the connector 500 with an exemplary configuration of a fastener assembly 600 including a primary fastener 604 and a keeper 606. The primary fastener 604 includes an eye 622 and a shank portion 624 which can include a thread to be threadably connected to the base 510. Although shown in the connector 500, the primary fastener 604 and keeper 606 can be used with any of the configurations described herein.

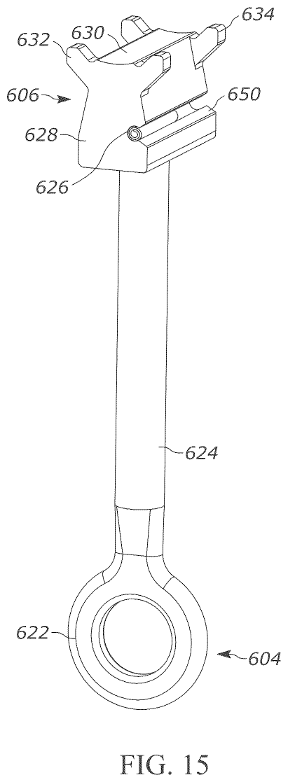

As best shown in FIG. 15, the keeper 606 is connected to the end of the primary fastener 604 by a retaining pin 626. The keeper 606 can include a keeper body 628 having one or more projections. The upper projection can include a curved outer surface 630 for receiving a conductor. The upper projection can also include a first set of arms 632 and a second set of arms 634 that extend outwardly from the keeper 606 to form a larger seat for receiving the primary conductor. The arms 632, 634 can extend past the walls of the cable groove 616 when a conductor is seated in the cable groove 616 and the primary fastener is tightened to secure the conductor.

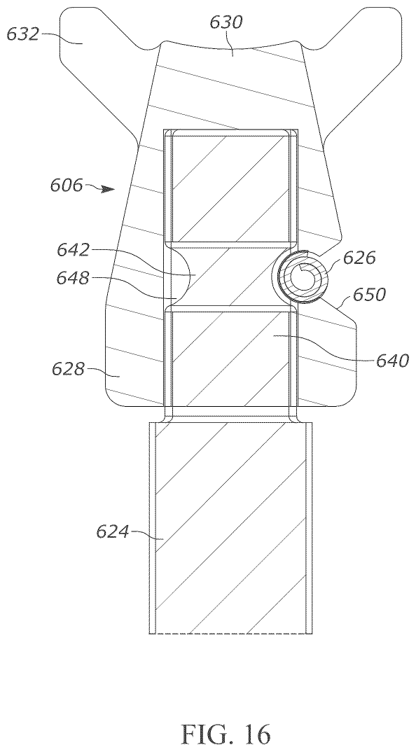

FIG. 16 shows an exemplary configuration of the interior of the keeper body 628 engaging the upper portion of the primary fastener 604. A head 640 can extend from the shank 624 with a reduced diameter. A groove 642 is formed around the head 640 with a further reduced diameter. The groove 642 can include curved walls sloping from the head on each side to a central region.

The keeper body 628 can include a central opening 648 configured to receive the head 640 and a slot 650 configured to receive the retaining pin 626. The slot 650 defines an opening positioned on the longitudinal side of the keeper body 628, for example facing the side portion 512. The slot 650 can extend from the opening through the keeper body 628 and be in communication with the central opening 648.

The width of the slot 650 can taper from the opening toward a central portion of the keeper body 628. In certain configurations, the taper is defined by angled side walls extending toward one another which join with a circular recess. Other configurations can be used.

The retaining pin 626 can be inserted into the slot 650 and seated in the circular recess where it will also be positioned in the groove 642 in the head 640. The retaining pin 626 can engage the groove 642 and the portion of the head 640 adjacent the groove 642 to help resist disengagement of the keeper 606 from the primary fastener 604.

In certain configurations, the retaining pin 626 can be a coiled spring pin. The coil spring pin can be compressed as it is pressed into the slot 650 and can provide a biasing force due to its spring force of expansion to help retain the pint 626 in the slot 650. In other configurations, other types of retaining pins can also be used.

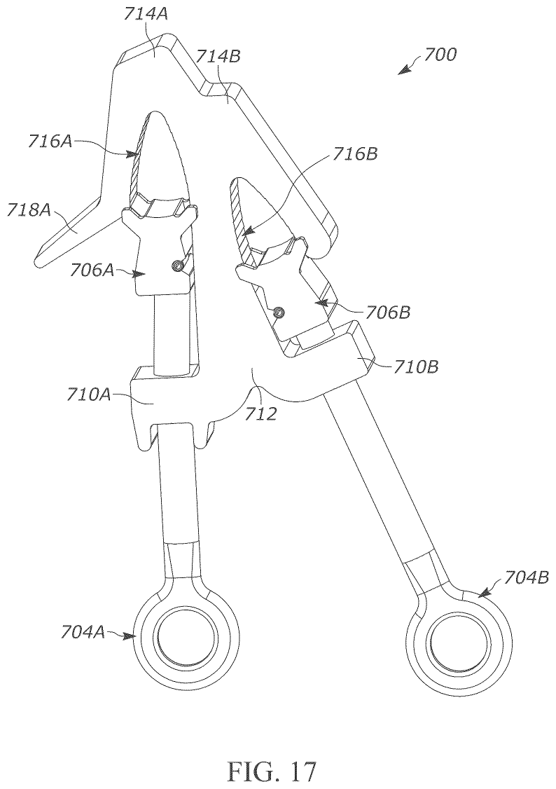

FIG. 17 shows an exemplary embodiment of a connector 700 having a piggyback clamp configuration. The connector 700 has a clamp body 702, a primary fastener 704A, a primary keeper 706A, a secondary fastener 704B, and a secondary keeper 706B. The primary keeper 706A and secondary keeper 706B can each have a configuration as shown in FIGS. 14-16. The hot line connector 700 is configured to receive a primary conductor and a secondary conductor in the clamp body 702 to make an electrical connection between the two conductors.

In various embodiments, the clamp body includes a primary base 710A with an aperture for receiving the primary fastener 704A and a secondary base 710B with an aperture for receiving the secondary fastener 704B. A side portion 712 extends upwardly from the primary base 710A and the secondary base 710B. A first upper portion 714A extends outwardly from the side portion 712 and defines a primary cable groove 716A. A second upper portion 714B extends outwardly from the side portion 712 and defines a secondary cable groove 716B. In certain configurations, the second upper portion 714B can be spaced below the first upper portion 714A forming a tiered upper edge.

The first upper portion 714A can include a forward extension 718A which extends outwardly from the primary cable groove 716A. The extensions 718A can extend at an oblique angle away from the first cable groove 716A and down toward the first base 710A. The secondary cable groove 716B and the secondary fastener 704B can be oriented at an oblique angle to the primary cable groove 716A and the primary fastener 704A.

The foregoing detailed description has been provided for the purpose of explaining the general principles and practical application, thereby enabling others skilled in the art to understand the disclosure for various configurations and implementations, and with various modifications as are suited to the particular uses contemplated. This description is not necessarily intended to be exhaustive or to limit the disclosure to what is disclosed. Any of the configurations and/or elements disclosed herein may be combined with one another to form various additional embodiments not specifically disclosed. Accordingly, additional configurations and implementations are possible and are intended to be encompassed within this specification and the scope of the appended claims. The specification describes specific examples to accomplish a more general goal that may be accomplished in another way.

As used in this application, the terms “front,” “rear,” “upper,” “lower,” “upwardly,” “downwardly,” and other orientational descriptors are intended to facilitate the description of the exemplary embodiments of the present disclosure, and are not intended to limit the structure of the exemplary embodiments of the present disclosure to any particular position or orientation. Terms of degree, such as “substantially” or “approximately” are understood by those of ordinary skill to refer to reasonable ranges outside of the given value, for example, general tolerances associated with manufacturing, assembly, and use of the described embodiments. Unless specified or limited otherwise, the terms “mounted,” “connected,” “supported,” and “coupled” and variations thereof are used broadly and encompass both direct and indirect mountings, connections, supports, and couplings. The words “member,” “component,” “module,” “mechanism,” “element,” “device,” and the like are not a substitute for the word “means.” As such, no claim element should be construed as a means plus function unless the element is expressly recited using the phrase “means for.”

What is claimed:

1. An electrical connector comprising:
a clamp body having a base, a side portion, and an upper portion, the clamp body defining a cable groove having an arched configuration configured to receive a primary conductor and an aperture for receiving a secondary conductor;
a primary fastener movably connected to the clamp body;
a keeper connected to the clamp body and moveable with the primary fastener to secure the primary conductor in the cable groove; and
a secondary fastener configured to receive the secondary conductor in the aperture.

2. The electrical connector of claim 1, wherein the cable groove has an ogival arch configuration.

3. The electrical connector of claim 1, wherein the primary fastener includes an eye.

4. The electrical connector of claim 1, wherein the primary fastener is threadably connected to the base.

5. The electrical connector of claim 1, wherein the keeper is rotatably connected to the fastener.

6. The electrical connector of claim 1, wherein a plurality of teeth extend into the cable groove, the plurality of teeth extending from an inner wall at a downward angle.

7. The electrical connector of claim 1, wherein the keeper is connected to the primary fastener with a retaining pin.

8. The electrical connector of claim 7, wherein the keeper includes a slot receiving the retaining pin.

9. The electrical connector of claim 1, wherein the clamp body is configured to provide a spring force to the secondary conductor when engaged with the secondary fastener.

10. The electrical connector of claim 1, wherein the clamp body includes a boss having a cantilever rear wall, the secondary fastener extending through the rear wall to engage the secondary conductor.

11. The electrical connector of claim 1, wherein the aperture includes a second cable groove having an arched configuration and wherein a secondary keeper is connected to the clamp body and moveable with the secondary fastener to secure the secondary conductor in the second cable groove.

12. An electrical connector comprising:
a clamp body having a base, a side portion, an upper portion, and a boss, the clamp body defining a cable groove configured to receive a primary conductor and an aperture for receiving a secondary conductor;
a primary fastener movably connected to the clamp body;
a keeper connected to the clamp body and moveable with the primary fastener to secure the primary conductor in the cable groove; and
a secondary fastener configured to secure the secondary conductor in the aperture,
wherein the clamp body is configured to provide a spring force to the secondary conductor when engaged with the secondary fastener.

13. The electrical connector of claim 12, wherein the boss includes a cantilever rear wall receiving the secondary fastener.

14. The electrical connector of claim 13, wherein the boss includes an upper arm spaced from the rear wall.

15. The electrical connector of claim 13, wherein the rear wall deflects when clamping the secondary fastener to the secondary conductor.

16. The electrical connector of claim 12, wherein rear wall extends from a lower wall extending from the side portion.

17. The electrical connector of claim 12, wherein the boss includes a lower opening for receiving the secondary conductor in a vertical orientation and a pair of side openings for receiving the secondary conductor in a vertical orientation.

18. An electrical connector comprising:
a clamp body having a base, a side portion, and an upper portion, the clamp body defining a cable groove configured to receive a primary conductor and an aperture for receiving a secondary conductor;
a primary fastener movably connected to the clamp body;
a keeper connected to the clamp body and moveable with the primary fastener to secure the primary conductor in the cable groove;
a retaining pin received in the keeper to secure the keeper to the primary fastener; and
a secondary fastener configured to receive the secondary conductor in the aperture.

19. The electrical connector of claim 18, wherein the keeper includes a slot receiving the retaining pin.

20. The electrical connector of claim 19, wherein the slot includes opposing angled walls a tapering toward a center of the keeper.
